(19) United States
(12) Patent Application Publication
(10) Pub. No.: US 2022/0379233 A1
(43) Pub. Date: Dec. 1, 2022

(54) GRID-LIKE SYMMETRICAL DISTRIBUTOR OR COLLECTOR ELEMENT

(71) Applicant: Hirschberg Engineering AG, Winterthur (CH)

(72) Inventor: Sebastian HIRSCHBERG, Winterthur (CH)

(21) Appl. No.: 17/773,550

(22) PCT Filed: Oct. 10, 2020
(86) PCT No.: PCT/EP2020/078522

§ 371 Date: Apr. 29, 2022

(30) Foreign Application Priority Data
Nov. 5, 2019 (EP) 19207308.8

(51) Int. Cl. B01D 3/00; B01F 35/71; B01J 4/00; B01J 8/02

(52) U.S. Cl. CPC B01D 3/008; B01F 35/7182; B01J 4/005; B01J 8/0278; B01J 2208/00938

(57) ABSTRACT

A distributor element comprising: at least three plates, each plate comprising openings, each of the levels between adjacent plates having walls extending from one side of one plate onto an adjacent side of an adjacent plate to define a channel, the channels fluid-tightly connecting all of the openings between adjacent plates, in each of the levels between the walls, one or more hollow spaces being formed, each of the plates comprising at least one aperture not being fluid-tightly connected with the openings of an adjacent plate by a channel, in each level between the at least one aperture of the adjacent plate at least two fluid paths extend in the one or more hollow spaces, all of the at least two fluid paths of each level having a substantially same length, and a number of fluid paths increasing at least for 75% of the plates from level to level.

### CROSS-REFERENCE TO RELATED APPLICATION

This application is a U.S. National Stage application of International Application No. PCT/EP2020/078522, filed Oct. 10, 2020, which claims priority to European Patent Application No. 19207308.8, filed Nov. 5, 2019, the contents of each of which are hereby incorporated by reference.

### BACKGROUND

### Field of the Invention

The present disclosure relates to a distributor element for uniformly distributing a first fluid on a cross-sectional plane or collecting the first fluid distributed on the cross-sectional plane, such as on a cross-sectional plane of a mass transfer column, a mixer, a disperser, a foaming device, or a chemical reactor, wherein a second fluid flows in at least one of co-current flow and counter-current flow with regard to the first fluid through the distributor element. In addition, the present disclosure relates to an apparatus, such as a mass transfer column, which comprises one or more of such distributor elements and/or collector elements.

### Background Information

In many technical processes, a fluid has to be uniformly distributed on a cross-sectional plane of an apparatus, while a second fluid flows through this plane. Both fluids may be a liquid or a gas or one of the fluids is a gas, while the other is a liquid. Examples of such processes are mass-transfer processes, such as rectification, absorption and the like, mixing processes, dispersing processes, foaming processes or the like and examples of respective apparatuses are chemical reactors, rectification columns, absorption columns, gas scrubbers, falling film evaporators, film crystallizers, gas drying apparatuses, mixing devices and the like.

Typically, a distributor element is used together with another device, wherein the distributor element uniformly distributes a first fluid on or across, respectively, a cross-sectional plane of the other device. The other device is, for instance, in a mass transfer process any type of packing, such as a structured packing, whereas the device is in chemical reactors a reactor, which is operated with different types of heterogenous or homogeneous catalysts, in falling film evaporators or film crystallizers a pipe bundle, in gas scrubbers and gas drying apparatuses a packing or a mixer, in apparatuses for absorption of gas in a liquid, for dispersing or for foaming one or more static mixer(s).

Conventional distributor elements for liquids comprise open channels, through which liquid is transferred in regular distances through openings directly or via sheets indirectly onto the plane, such as the surface of a structured packing in a mass transfer column. Such distributor elements are described for example in U.S. Pat. No. 4,855,089, in U.S. Pat. No. 3,158,171 and in EP 0 112 978 B1. However, these distributor elements are expensive. A further disadvantage of these distributor elements is that it has to be assured during their operation that the liquid level in all channels is the same, since the liquid level determines the volume flow through the channel openings. Moreover, at least some of these distributor elements have a comparable high pressure loss and hinder the flow of the second fluid. The same applies for respective collector elements.

In order to distribute gas, distribution lances are often applied. These distribution lances comprise nozzles, which have to be configured such that during the operation the volume flow therethrough is the same. Similar distribution lances may be used for distributing liquids. A plurality of such distribution lances may be combined to form a lance grid. However, these distributor elements are also expensive and complex to be operated, have a comparable high pressure loss and hinder the flow of the second fluid. The same applies for respective collector elements.

In view thereof, the object underlying the present disclosure is to provide a distributor element, which uniformly distributes with a high distribution density a first fluid on a cross-sectional plane, or a collector element, which uniformly collects the first fluid distributed on the cross-sectional plane, in particular on the cross-sectional plane of a mass transfer column, while it essentially does not interfere with the flow of a second fluid through the plane, wherein the distributor or collector element is easy and cost-efficient to produce.

In accordance with an embodiment of the present disclosure, this object is satisfied by providing a distributor element for uniformly distributing a first fluid on a cross-sectional plane or collecting the first fluid distributed on the cross-sectional plane, wherein a second fluid flows in at least one of co-current flow and counter-current flow with regard to the first fluid through the distributor element, the distributor element comprising: at least three plates arranged at least substantially parallel to each other, one of a plurality of levels being defined between each of two adjacent plates of the at least three plates, each of the plates comprising a number of openings, each of the levels having walls arranged therein, each of the walls extending from one side of one of the at least three plates onto an adjacent side of an adjacent plate of the at least there plates such that each of the walls defines one of a plurality of channels through which the second fluid flows, the channels fluid-tightly connecting all of the openings between adjacent plates of the at least three plates, in each of the levels between the walls defining the channels, one or more hollow spaces being formed, through which the first fluid is configured to flow, each of the at least three plates comprising at least one aperture not fluid-tightly connected with one or more of the openings of an adjacent plate of the at least three plates one of a plurality of channels, the at least one aperture arranged adjacent to the one or more hollow spaces of adjacent levels such that in each level between the at least one aperture of the adjacent plate, at least two fluid paths extend in the one or more hollow spaces of the level, all of the at least two fluid paths of each level having a substantially same length, and a number of fluid paths increasing, as seen in a direction from one outermost plate to an opposite outermost plate of the distributor element, at least for 75% of the plates from level to level.

The collector element in accordance with an embodiment of the present disclosure is identical to the distributor element in accordance with an embodiment of the present disclosure. However, during its use the collector element is inverted with regard to the distributor element, i.e. the uppermost plate of the distributor element corresponds to the lowermost plate of the collector element and vice versa.

While the channels allow the second fluid, such as a gas, to flow, such as ascend, through the distributor or collector element essentially without interference, the fluid paths defined in the hollow spaces between the walls defining the channels of each level allow the first fluid, such as liquid, to be distributed over the cross-sectional plane of the distributor element or collected over the cross-sectional plane of the collector element, respectively. Since the number of fluid paths increases, as seen in the direction from the one outermost plate to the opposite outermost plate of the distributor, from level to level, the distribution density of the first fluid increases in the same direction assuring in the outermost level of the distributor element an excellently uniform distribution of the first fluid over the cross-sectional plane of the distributor element. Or, seen in the other direction of the collector element, the change of the number of fluid paths assures an efficient collection of the first fluid over the cross-sectional plane of the outermost plate of the collector element and an efficient concentration of the first fluid in one point of the opposite outermost plate of the collector element. The uniform distribution of the first fluid over the cross-sectional plane of the distributor element is efficiently enhanced by the fact that all of the fluid paths of each level have substantially the same length and flow resistance. On account of this reason, the first liquid flows uniformly through all available fluid paths and not selectively through some more than others. Therefore, the provision of fluid paths having substantially the same length (and thus the same flow resistance) and the increment of the number of fluid paths, seen in the direction from the one outermost plate to the opposite outermost plate, from level to level synergistically lead together to the excellent uniform distribution from level to level of the distributor element during its use. All in all, the distributor element in accordance with the present disclosure allows excellent uniform distribution of a first fluid, such as liquid, on a cross-sectional plane of for instance a mass transfer column, while essentially not interfering with the flow of a second fluid through the plane and consequently has during operation a low pressure loss. Likewise, the collector element in accordance with the present disclosure allows uniform collection of a first fluid, such as liquid, distributed on a cross-sectional plane of for instance a mass transfer column, while essentially not interfering with the flow of a second fluid through the plane and consequently has during operation a low pressure loss. In particular, the distributor element in accordance with an embodiment of the present disclosure allows one to obtain a particular high distribution density, and the collector element in accordance with an embodiment of the present disclosure allows one to collect fluid distributed on a cross-sectional plane in a particular high distribution density. Particularly, the present disclosure allows one to easily and cost-efficiently obtain a distributor element having at its bottom up to 200,000 and even up to 1,500,000 fluid outlets per square meter. The commercially available distributor elements only have 100 to 200 fluid outlets per square meter. A further particular advantage of the present disclosure is that the distributor element can be, as described in detail further below, easily and cost-efficiently produced in particular by a generative production method, such as by screen printing.

The terms “opening” and “aperture” are each used in accordance with the present disclosure with the same meaning, namely recess or hole, respectively, in a plate. However, in order to improve the clarity, the term “opening” is used exclusively for a recess or hole of a plate, which is fluid-tightly connected with one or more opening(s) of an adjacent plate by a channel, whereas the term “aperture” is used exclusively for a recess or hole of a plate not fluid-tightly connected with one or more openings of an adjacent plate by a channel. On the contrary, any “aperture” is adjacent to one or more hollow spaces of the level(s), to which the aperture is adjacent.

In addition, the term that the channels “fluid-tightly connect all openings between adjacent plates” means that the channels surround the openings of adjacent plates and connect them with each other so that second fluid flowing through the opening of one plate is guided by the inner wall of the channel to the opening of the adjacent plate and cannot enter the hollow space (through which the second fluid flows) outside the channels. This does not necessarily mean that each channel fluid-tightly connects exactly one opening of the plate with exactly one opening of the adjacent plate. On the contrary, it is possible that one channel connects exactly one opening of the plate with two or more openings of the adjacent plate or even that one channel connects two or more openings of the plate with two or more openings of the adjacent plate. However, any opening of the plate is connected with at least one opening of the adjacent plate and any opening of the adjacent plate is connected with at least one opening of the plate. Thus, the channels “fluid-tightly connect all openings between adjacent plates” and simultaneously fluid-tightly separate the interior of the channels from the hollow spaces of the levels. In order to achieve this, the channel wall is typically attached to a side of the plate such that it completely surrounds or covers or encases, respectively, the opening, whereas the channel wall extends from this side of the plate through the adjacent level onto the opposite side of the adjacent plate, where it completely surrounds or covers, respectively, one or more openings of the adjacent plate.

Moreover, the term “at least substantially parallel to each other” means in accordance with the present disclosure that two adjacent plates are not inclined in relation to each other by more than 10°, preferably by not more than 5°, more preferably by not more than 2° and still more preferably by not more than 1°. Most preferably, two adjacent plates are arranged parallel to each other, i.e. they are not inclined in relation to each other.

Furthermore, the term “level” means in accordance with the present disclosure the space between an upper plate and a lower plate, wherein in this space the channels through which the second fluid flows and the hollow space(s) defining the fluid paths are arranged. Each “level” comprises the channels, with are separated from each other by the hollow spaces. Thus, the total volume of each level is the sum of the volumes of the channels plus the sum of the volume(s) of the hollow space(s).

Accordingly, the term “hollow space” means the total volume of a level minus the sum of the volumes of the channels minus optional further components provided in the level, such as partition walls or the like, i.e. the “hollow space” is a 3-dimensional space. If in the level no partition wall(s) or the like are provided connecting some of the outsides of two or more of the channel walls with each other, the level will only comprise one hollow space. However, it is possible to connect some outsides of two or more of the channel walls with each other for instance by one or more partition walls to subdivide the remaining hollow space into several hollow spaces.

In contrast to the term “hollow space”, the term “fluid path of a level” means in accordance with the present disclosure the line from an aperture of a plate adjacent to the hollow space of a level through the hollow space to an aperture of an adjacent plate on the opposite site of the hollow space of the same level. Except for only theoretical possible designs of the plates, any level will in practice comprise more than one fluid path, even if the level only comprises one hollow space. This is in particular the case, when at least one of the plates has more than one aperture. In other words, a “fluid path of a level” is the line (or path, respectively) that a liquid may take, when it enters the hollow space of the level via the aperture of one plate and leaves the hollow space on the opposite side of the same level via one of the apertures of the adjacent plate. All in all, while the “hollow space” is a volume (namely to total volume of a level minus the sum of the volumes of the channels), the “fluid path” is a line (or path, respectively) connecting an aperture of a plate through the hollow space with the aperture of an adjacent plate. Accordingly, the length of a “fluid path of a level” is the distance from the aperture a plate following the fluid path through the hollow space of the level until the aperture of the adjacent plate, whereas the length of a “fluid path of a distributor or collector element” is the distance from an aperture of the first outermost plate following the fluid paths through the hollow spaces of all of the levels until the aperture of the opposite outermost plate of the distributor or collector element.

“Fluid paths of each level” having “substantially the same length” means in accordance with the present disclosure that each of the fluid paths of the level does not vary more in the length compared to the length of any other fluid path of the same level by more than 20%, preferably not more than 10%, more preferably not more than 5%, even more preferably not more than 2% and still more preferably not more than 1%. Most preferably of course, all fluid paths of each level have exactly the same length.

In addition, “a second main fluid flows in co-current flow and/or in counter-current flow with regard to the first fluid through the distributor or collector element” means that the second fluid flows from the lowermost edge of the element to the uppermost edge of the element or vice versa and that also the first fluid flows from the lowermost edge of the element to the uppermost edge of the element or vice versa.

Finally, the term “the number of fluid paths increases, as seen in the direction from the first outermost plate to the opposite outermost plate of the distributor or collector element, at least for 75% of the plates from level to level” means that at least 75% of all plates of the distributor or collector element have a lower number of fluid paths than a plate adjacent in the direction seen from the first outermost plate to the opposite outermost plate, i.e. adjacent behind the plate. Thus, if the distributor or collector element comprises three plates, all plates must fulfill this criterion. If the distributor or collector element comprises four to seven plates, all but one plate must fulfill this criterion, if the distributor or collector element comprises eight to eleven plates, all but two plates must fulfill this criterion.

It is particularly preferred that the channels through which the second fluid flows are fluid-tightly separated by the walls from all of the one or more hollow spaces defining the fluid paths, through which the first fluid is configured to flow.

It is a matter of course that the effects of the present disclosure are obtained to a higher degree, when more plates fulfill the aforementioned criterion. Accordingly, it is preferred that the number of fluid paths increases, as seen in the direction from a first outermost plate to the opposite outermost plate of the distributor or collector element, at least for 80%, more preferably for at least for 90%, even more preferably for at least for 95%, still more preferably for at least for 98% and most preferably for all of the plates from level to level.

In accordance with a first preferred embodiment of the present disclosure, the increment of the number of fluid paths from level to level is achieved by increasing the number of channels, as seen in the direction from the first outermost plate to the opposite outermost plate of the distributor, from level to level. By increasing the number of channels, the number of channel walls and thus the number of deflection points in the hollow space of the level is increased, and thereby the number of fluid paths increases.

In accordance with a second preferred embodiment of the present disclosure, the increment of the number of fluid paths from level to level is achieved by increasing the number of apertures of a plate, as seen in the direction from the first outermost plate to the opposite outermost plate of the distributor, from level to level. By increasing the number of apertures, the number of possible lines to follow by the first fluid in the hollow space of the level is increased, and thereby the number of fluid paths increases.

In accordance with a third preferred embodiment of the present disclosure, the first and second preferred embodiments are combined, i.e. the increment of the number of fluid paths from level to level is achieved by increasing the number of channels, as seen in the direction from the first outermost plate to the opposite outermost plate of the distributor, from level to level and by increasing the number of apertures of a plate, in the same direction, from level to level.

In a further embodiment of the present disclosure, it is preferred that the lengths of at least 80% of the fluid paths extending from an aperture of the first outermost plate to an aperture of the opposite outermost plate of the distributor element are at least substantially the same. In this embodiment not only the fluid paths of the same level have substantially the same length, but also the fluid paths extending through the entire distributor element. Also, in this embodiment, “at least substantially the same length” means that each of the fluid paths does not vary more in the length compared to the length of any other fluid path by more than 20%, preferably not more than 10%, more preferably not more than 5%, even more preferably not more than 2% and still more preferably not more than 1%. Most preferably of course, all fluid paths extending through the entire distributor or collector element of each level have exactly the same length.

In order to feed the first fluid into the first level in a controlled manner, it is suggested in a further embodiment of the present disclosure that the first outermost of the at three plates comprises an inlet through which the first fluid is transferred into hollow space comprising the fluid paths of the first level. The inlet may have the form of a pipe, which covers an aperture of the first outermost plate so that the first fluid may flow through the pipe and through the aperture into the hollow space comprising the fluid paths of the first level. Preferably, the aperture and thus also the inlet are arranged centrally in and on the plate, respectively.

More preferably, the lengths of at least 90%, even more preferably of at least 95%, still more preferably of at least 98% and most preferably of all the fluid paths extending from an aperture of the first outermost plate to an aperture of the opposite outermost plate of the distributor element are at least substantially the same.

In accordance with another preferred embodiment of the present disclosure, it is suggested that all of the openings of at least one of the at least three plates of the distributor or collector element are at least substantially regularly arranged in the at least one plate. More preferably, all of the openings of each of the at least three plates are at least substantially regularly arranged in each of the at least three plates. This allows one to easily and precisely assure that all fluid paths of the level have substantially the same length. In this embodiment, it is further preferred that also all of the channels of each of the at least three plates are at least substantially regularly arranged in each level between each adjacent two of the at least three plates, meaning that the channels are extending perpendicular with regard to the surface of the plate towards that of the adjacent plate.

An at least substantially regular arrangement of the channels in each of the at least three plates means that preferably each of the distances between the center point of one opening and the center point of the closest adjacent opening of at least one and preferably of each of the at least three plates is 80 to 120% of the average distance of the center points of all openings and their closest adjacent openings of the respective plate. The average distance of the center points of all openings with their closest adjacent openings of the respective plate is determined by measuring the distances between the center points of each opening and the center point of its closest opening of the plate, by summing up all these measured distances of the plate and by dividing the sum by the number of openings of the plate.

Such a regular arrangement may be easily achieved, when the openings of each of the at least three plates are arranged in at least a substantially grid-like manner in at least one and preferably in each of the at least three plates. In this case, the plate is a framework surrounding the openings and apertures, i.e. the framework of a plate is formed by all parts of the plate except the openings and apertures, i.e. except all holes, recesses or the like.

For instance, the framework of each of the at least three plates comprises, and preferably consists of, at least substantially parallel and crossed bars, wherein a first half of the bars is arranged in the length direction and a second half of the bars is arranged in the width direction of the plate. The angle between each of the bars of the first half and each of the bars of the second half is 70 to 110°, preferably 80 to 100°, more preferably 85 to 950 and most preferably about 90°, wherein the angle of each bar of the first half and each of its adjacent bars of the first half is 160 to 200°, preferably 170 to 190°, more preferably 175 to 185° and most preferably about 180°, and wherein the angle of each bar of the second half and each of its adjacent bars of the second half is 160 to 200°, preferably 170 to 190°, more preferably 175 to 185° and most preferably about 180°.

The present disclosure is not particularly limited concerning the form of the openings of the at least three plates. For example, the openings may have a circular, an elliptic, an oval, a rectangular or a square cross-sectional form. Preferably, all openings have the same form and all openings of each plate have the same dimensions. Good results are in particular obtained, when the openings of each plate have an at least substantially rectangular or square cross-sectional form, wherein the edges of the openings of the rectangle or square, respectively, may be rounded. Substantially rectangular or square means that each opening is bordered by four linear edges of the framework of the plate, wherein each the angles between any two of the four linear edges is 70 to 110°, preferably 80 to 100°, more preferably 85 to 95° and most preferably about 900.

In order to easily achieve a regular pattern of the openings and at least a substantially same length of fluid paths in the adjacent level, it is proposed in a further embodiment of the present disclosure that the openings of at least one of and preferably each of the at least three plates are arranged in the respective plate in (2)^{m} rows and (2)^{m} columns, wherein m is an integer of 1 to 10, preferably of 1 to 8 and more preferably of 2 to 6.

Good results are in particular achieved, when also all of the apertures of at least one of the at least three plates are at least substantially regularly arranged in the at least one plate and preferably all of the apertures of each of the at least three plates are at least substantially regularly arranged in each of the at least three plates. Also, this embodiment allows one to easily assure that the lengths of all of the fluid paths in the adjacent level are at least substantially the same. An at least substantially regularly arrangement of apertures means in this connection that each of the distances between the center point of one aperture and the center point of the closest adjacent aperture of at least one and preferably of each of the at least three plates is 80 to 120% of the average distance of the center points of all apertures and their closest adjacent apertures of the respective plate. The average distance of the center points of all apertures with their closest adjacent apertures of the respective plate is determined by measuring the distances between the center point of each aperture and the center point of its closest aperture of the plate, by summing up all these measured distances of the plate and by dividing the sum by the number of apertures of the plate.

The present disclosure is not particularly limited concerning the form of the apertures of the at least three plates. For example, the apertures of at least one of and preferably of each of the at least three plates are at least substantially circular, cross-shaped, rectangular or square, preferably at least substantially circular or cross-shaped and most preferably circular or cross-shaped.

The number of plates of the distributor or collector element in accordance with an embodiment of the present disclosure depends on the specific application. However, in general it is preferred that the distributor or collector element comprises 3 to 15, more preferably 3 to 12, still more preferably 3 to 10 and most preferably 3 to 5 plates, which are arranged at least substantially parallel to each other defining a level between each two adjacent plates.

All plates of the distributor or collector element may be arranged at least substantially horizontal. Substantially horizontal means that each plate does not vary in relation to the horizontal plane by more than 10°, preferably by not more than 5°, more preferably by not more than 2° and still more preferably by not more than 1°. Most preferably, each plate is arranged horizontally, i.e. is not inclined in relation to the horizontal plane.

As set out above, in accordance with a first preferred embodiment of the present disclosure, the increment of the number of fluid paths from level to level is achieved by increasing the number of channels, as seen in the direction from the first outermost plate to the opposite outermost plate of the distributor or collector element, from level to level. This may be achieved by using fractal plates. Fractal plate is defined in accordance with the present disclosure as a plate having, if arranged (as seen in the direction from the first outermost plate to the opposite outermost plate) behind another plate, a higher number of openings than the other plate and, if it is the first outermost plate of the distributor or collector element, a lower number of openings than the adjacent plate.

The number of fractal plates of the distributor or collector element in accordance with an embodiment of the present disclosure depends on the specific application. However, in general it is preferred that the distributor or collector element comprises at least two, preferably at least three, more preferably 2 to 15, yet more preferably 3 to 12, still more preferably 3 to 10 and most preferably 3 to 5 fractal plates, wherein each of the fractal plates comprises a lower number of openings than a fractal plate that is adjacent behind (i.e. adjacent in the direction from the first outermost to the opposite outermost fractal plate of the distributor or collector element) the fractal plate. Preferably, all fractal plates are adjacent to each other, without having any non-fractal plate therebetween.

Good results are in particular achieved, when all fractal plates are adjacent to each other without having any non-fractal plate therebetween, with the first fractal plate the outermost plate of the distributor or collector element.

In order to easily and reliably achieve an at least substantially same length of the fluid paths of a level, it is further suggested that the openings of the each of the fractal plates are arranged in at least a substantially grid-like pattern in the respective plate. This is easily achievable, when the openings of each of the fractal plates are at least substantially rectangular or square.

In accordance with the present embodiment, the number of openings in each fractal plate (or forward fractal plate, respectively) is lower than the number of openings of a fractal plate (or backward fractal plate, respectively) adjacent thereto in the direction from the first outermost to the opposite outermost plate of the distributor or collector element. All terms, “forward”, “backward”, “before”, “behind” and the like in connection with the relative arrangement of the single plates are to be understood in relation to the direction from the first outermost to the opposite outermost plate of the distributor or collector element. The first outermost plate of the distributor or collector element is that of the two outermost plates of the distributor or collector element, which adjacent level has less fluid paths than the level adjacent to the other of the two outermost plates of the distributor or collector element. In order to achieve an excellently uniform distribution of the first fluid over the cross-sectional plane it is preferred that the number of openings in each backward fractal plate is a multiple of the number of openings in the respective adjacent forward fractal plate. Particularly good results are obtained as a compromise between the desire to minimize the total number of fractal plates in the distributor or collector element and the desire of achieving a very high distribution density, when each backward fractal plate comprises 4-times more openings than the adjacent forward fractal plate. Therefore, it is particularly preferred that the number of openings in each fractal plate is 4×(4)ⁿ, wherein n is the number of the respective fractal plate in relation to the first outermost fractal plate, with the first outermost fractal plate fractal plate 1.

As set out above, the number of openings in each backward fractal plate is higher than the number of openings in the respective adjacent forward fractal plate. Likewise thereto, it is preferred that the number of apertures in each backward fractal plate is higher than the number of apertures in the respective adjacent forward fractal plate. More specifically, it is preferred that each fractal plate comprises a plurality of apertures, wherein the number of apertures is between 0.1 and 200%, preferably between 0.5 and 50%, more preferably between 1 and 20%, still more preferably between 3 and 10% and most preferably about 6.25% of the number of openings in the same fractal plate.

As set out above, in accordance with a second preferred embodiment of the present disclosure, the increment of the number of fluid paths from level to level is achieved by increasing the number of apertures of a plate, seen in the direction from the first outermost plate to the opposite outermost plate of the distributor or collector element, from level to level. This may be achieved by using at least one distribution plate. Distribution plate is defined in accordance with the present disclosure as a plate having, if arranged (seen in the direction from the first outermost plate to the opposite outermost plate) behind (i.e. backwards) another plate, the same number of openings as the other plate (i.e. that arranged before, i.e. which forwards) and, if it is the first outermost plate of the distributor or collector element, the same number of openings as the adjacent plate.

The number of distribution plates of the distributor or collector element in accordance with an embodiment of the present disclosure depends on the specific application. However, in general it is preferred that the distributor or collector element comprises at least two, preferably at least three, more preferably 3 to 15, yet more preferably 3 to 12, still more preferably 3 to 10 and most preferably 3 to 5 distribution plates, wherein each of the distribution plates has a higher number of apertures than the adjacent forward plate, if present.

Preferably, each of the at least one distribution plate has the same form as the adjacent forward plate and, if no adjacent forward plate is present, the same form as the adjacent backward plate, and wherein the openings are formed in each of the at least one distribution plate at the same locations as in the adjacent forward plate and, if no adjacent upper plate is present, at the same locations as in the adjacent backward plate.

Good results are in particular achieved, when all distribution plates are adjacent to each other, without having any non-distribution plate therebetween. If the distributor or collector element comprises at least one fractal plate, it is preferred that all distribution plates are adjacent to each other, without having any non-distribution plate therebetween, and are arranged—as seen in the direction from the first outermost plate to the opposite outermost plate—behind all of the at least one fractal plate.

In order to easily and reliably achieve an at least substantially same length of the fluid paths of a level, it is further suggested that the openings of the each of the distribution plates are arranged in at least a substantially grid-like pattern in the respective plate. This is easily achievable, when the openings of each of the distribution plates are at least substantially rectangular or square.

As set out above, in accordance with a third preferred embodiment of the present disclosure, the increment of the number of fluid paths from level to level is achieved by increasing the number of channels, as seen in the direction from the first outermost plate to the opposite outermost plate of the distributor or collector element, from level to level and by increasing the number of apertures of a plate, in the same direction, from level to level. In this embodiment, the distributor or collector element preferably comprises at least two, preferably at least three, more preferably 2 to 15, yet more preferably 3 to 12, still more preferably 3 to 10 and most preferably 3 to 5 fractal plates and 1 to 3 and preferably 2 or 3 distribution plates. Preferably, all fractal plates are adjacent to each other, without having any non-fractal plate therebetween, and all distribution plates are adjacent to each other, without having any non-distribution plate therebetween. Even more preferably, all distribution plates are arranged—as seen in the direction from the first outermost plate to the opposite outermost plate—behind all of the at least one fractal plate.

In accordance with a fourth preferred embodiment of the present disclosure, the distributor or collector element comprises only fractal plates and preferably 2 to 15, more preferably 3 to 12, still more preferably 3 to 10 and most preferably 3 to 5 fractal plates.

In accordance with a fifth preferred embodiment of the present disclosure, the distributor or collector element comprises only distribution plates and preferably 3 to 15, more preferably 3 to 12, still more preferably 3 to 10 and most preferably 3 to 5 distribution plates.

In a further variant of the third preferred embodiment of the present disclosure, the distributor or collector element comprises at least two fractal plates including a first outermost fractal plate and an adjacent second fractal plate, wherein the first outermost fractal plate has an at least substantially rectangular or square form and comprises 16 at least substantially rectangular or square openings arranged in a grid-like pattern, each of the openings having at least substantially the same size and form, wherein the 16 openings are arranged in the first outermost fractal plate equidistantly in 4 rows and 4 columns of openings. Preferably, each of the 16 openings of the first outermost fractal plate is surrounded by a wall extending at least substantially perpendicular from the lower surface of the first outermost fractal plate to the upper surface of the adjacent second fractal plate, thus forming in the first level between the first and second plate 16 closed channels to be flowed through by the second main fluid.

Openings having the same size means that the area of one of these openings does not vary by more than 20%, preferably by not more than 10%, more preferably not by more than 5% and most preferably not by more than 2% from the area of each of these openings.

Good results are achieved in this variant, when the second fractal plate arranged adjacent to the first outermost fractal plate has an at least substantially rectangular or square form and comprises 64 at least substantially rectangular or square openings arranged in a grid-like pattern, each of the openings having at least substantially the same size and form, wherein the 64 openings are arranged in the second fractal plate equidistantly in 8 rows and 8 columns of openings, wherein each of the 64 openings of the second fractal plate is surrounded by a wall extending at least substantially perpendicular from the lower surface of the second fractal plate to the upper surface of the behind third plate, thus forming in the second level (which is defined between the second and the adjacent behind third plate) 64 closed channels through which the second fluid flows. Preferably, the second fractal plate comprises 4 apertures connecting the hollow space comprising the fluid paths of the first level with those of the second level, wherein one aperture is formed at the crossing point between the four channels of the first and second columns of the first and second rows, one aperture is formed at the crossing point between the four channels of the third and fourth columns of the first and second rows, one aperture is formed at the crossing point between the four channels of the first and second columns of the third and fourth rows and one aperture is formed at the crossing point between the four channels of the third and fourth columns of the third and fourth rows.

Optionally, the one or more fluid paths may be defined by partition walls, which are appropriately placed in the hollow space(s) between channel walls. Alternatively, the single fluid path(s) may be formed by filling parts of the gaps formed between the channels through which the second fluid flows, whereas other gaps formed between the channels through which the second fluid flows remain open, thus forming the fluid path(s)

Moreover, it is preferred in this variant of the present disclosure that the distributor or collector element comprises at least a third fractal plate arranged behind the second fractal plate, wherein the third fractal plate has an at least substantially rectangular or square form and comprises 256 at least substantially rectangular or square openings arranged in a grid-like pattern, each of the openings having at least substantially the same size and form, wherein the 256 openings are arranged in the third fractal plate equidistantly in 16 rows and 16 columns of openings. Each of the 256 openings of the third fractal plate is surrounded by a wall extending at least substantially perpendicular from the lower surface from the third fractal plate to the upper surface of a behind plate, thus forming in the third level (which is defined between the third and the adjacent behind fourth plate) 256 closed channels through which the second fluid flows. Below each of the openings of the second fractal plate, 4 openings of the third fractal plate are placed.

In a further embodiment of the present disclosure, it is suggested that in this variant the third fractal plate comprises 16 apertures connecting the hollow spaces comprising the fluid paths of the second level with those of the third level, wherein the apertures are formed in the fluid paths at the crossing points between the channels of columns 1, 3, 5, 7, 9, 11, 13 and 15 of rows 1, 3, 5, 7, 9, 11, 13 and 15. Preferably, the distributor or collector element of this variant comprises behind the third fractal plate a fourth fractal plate having an at least substantially rectangular or square form and comprising 11,024 at least substantially rectangular or square openings arranged in a grid-like pattern, each of the openings having at least substantially the same size and form, wherein the 1,024 openings are arranged in the fourth fractal plate equidistantly in 32 rows and 32 columns of openings.

Good results are particularly achieved, when in the above variant behind the last fractal plate a distribution plate is arranged, which has the same form and same number and dimensions of openings as the last fractal plate, wherein the distribution plate has no apertures in the fluid paths at the crossing-points below those, in which the apertures of the last fractal plate are located, but wherein the distribution plate has apertures at any crossing-point adjacent to those, in which the apertures of the last fractal plate are located. Preferably, behind the distribution plate one to five, preferably one to four and more preferably two, three or four further distribution plates are arranged, which has/have the same form and same number and dimensions of openings as the last fractal plate and the distribution plate, wherein each of the further distribution plates has a higher number of apertures than its adjacent forward plate.

In a further embodiment of the present disclosure, it is proposed that the distributor or collector element of this variant comprises one to six, preferably one to five and more preferably two, three, four or five distribution plates, which all have the same form and same number and dimensions of openings, wherein each of the distribution plates has a higher number of apertures than its adjacent upper distribution plate.

As set out above, between each two plates a level is defined, through which the channels extend and in which the fluid paths are arranged. The height of each level, i.e. the distance between its upper and lower plate may be constant. However, in accordance with a further preferred embodiment of the present disclosure, the distance of the levels varies, whereas more preferably the height of each level decreases from the level adjacent to the first outermost plate to the level adjacent to the opposite outermost plate of the distributor or collector element. This has the advantage that the flow resistance within each level is not too high. The height of each level or at least of the first level may be between 0.2 and 250 mm, more preferably between 1 and 100 mm and most preferably between 2 and 50 mm.

The openings of each of the plates may have a diameter of 1 to 500 mm, more preferably of 1.5 to 100 mm and most preferably of 2 to 50 mm. As indicated above, it is preferred that the size or diameter, respectively, of the openings decreases from the first fractal plate to the last fractal plate, if any fractal plate is present. It is preferred that all openings of each plate have at least substantially the same size or diameter, respectively.

The apertures of each of the plates may have a size or diameter, respectively of 0.1 to 100 mm, more preferably of 0.2 to 50 mm and most preferably of 0.4 to 20 mm. It is preferred that all apertures of each plate have at least substantially the same size, such as diameter.

Each of the apertures having preferably at least substantially the same size means that the area of one of these apertures does not vary by more than 20%, preferably not by more than 10%, more preferably not by more than 5% and most preferably not by more than 2% from the area of each of these apertures.

Preferably, the lowest plate of the distributor element or the uppermost plate of the collector element has 1,000 to 1,500,000 and more preferably 20,000 to 200,000 fluid outlets per square meter.

The distributor or collector element, i.e. each of the plates, channel walls and, if present, partition walls, may be formed of any suitable material, such as a ceramic material, a plastic, a metal, an alloy, a composite material or the like. Particularly preferred materials are technical ceramics such as but not limited to silicon carbide, silicon nitride, aluminum oxide, mullite and cordierite or metal materials such as but not limited to aluminum alloys or stainless steel or a wide range of plastic materials.

A particular advantage of the distributor element in accordance with the present disclosure is that it may be easily produced by a generative method, such as screen printing, such as by a method described in WO 2016/095059 A1.

According to another embodiment, the present disclosure relates to an apparatus comprising one or more of the aforementioned distributor elements and/or one or more of the aforementioned collector elements.

For instance, the apparatus may be a mass transfer column, a mixer, a disperser, a foaming device, a chemical reactor, a crystallizer or an evaporator.

In accordance with a preferred embodiment of the present disclosure, the apparatus is a mass transfer column and comprises below the one or more distributor elements and/or above the one or more collector elements a mass transfer structure selected from the group consisting of: contact trays, random packings and structured packings.

In accordance with another preferred embodiment of the present disclosure, the apparatus is a mass transfer column and comprises below the one or more distributor elements and/or above the one or more collector elements a mass transfer structure, which has a honeycomb shape including capillaries, wherein the walls defining the channels are step-shaped or made of tissue or are arbitrarily formed open-cell foams. Such mass transfer structures are in more detail described in WO 2014/043823 A1 and in WO 2017/167591 A1.

In accordance with still another preferred embodiment of the present disclosure, the apparatus comprises below the one or more distributor elements and/or above the one or more collector elements a mass transfer structure, which comprises a contact zone designed to conduct a second fluid and designed such that the first fluid can be brought into contact with the second fluid, wherein in the contact zone at least one flow breaker is provided for interrupting a flow of the second fluid.

In accordance with yet another preferred embodiment of the present disclosure, the apparatus comprises below the one or more distributor elements and/or above the one or more collector elements a mass transfer structure selected from the group consisting of: tissues, open-pored materials, capillaries, step structures and arbitrary combinations of two or more of the aforementioned structures.

Another embodiment of the present disclosure is a method for uniformly distributing a first fluid on a cross-sectional plane or collecting the first fluid distributed on the cross-sectional plane comprising: flowing the first fluid into at least one of the one or more hollow spaces defining the fluid paths, and flowing a second fluid through the channels of the distributor element, wherein the distributor element is used in a mass transfer column, a mixer, a disperser, a foaming device or a chemical reactor.

### BRIEF DESCRIPTION OF THE DRAWINGS

FIG. 1 shows a perspective side view of a distributor element according to one embodiment of the present disclosure.

FIG. 2 shows a top view of the distributor element shown in FIG. 1.

FIG. 3A shows a cross-sectional view of the first level below the first fractal plate of the distributor element shown in FIG. 1.

FIG. 3B shows a schematic view of FIG. 3A.

FIG. 4A shows a cross-sectional view of the second level below the second fractal plate of the distributor element shown in FIG. 1.

FIG. 4B shows a schematic view of FIG. 4A.

FIG. 5A shows a cross-sectional view of the third level below the third fractal plate of the distributor element shown in FIG. 1.

FIG. 5B shows a schematic view of FIG. 5A.

FIG. 6A shows a cross-sectional view of the fourth level below the first distribution plate of the distributor element shown in FIG. 1.

FIG. 6B shows a schematic view of FIG. 6A.

FIG. 6C shows a schematic part of FIG. 6B magnified.

FIG. 7A shows a schematic view of the fifth level below the second distribution plate of the distributor element shown in FIG. 1.

FIG. 7B shows a schematic part of FIG. 7A magnified.

FIG. 7C shows a schematic view of the sixth level below the third distribution plate of the distributor element shown in FIG. 1.

FIG. 7D shows a schematic part of FIG. 7C magnified.

FIG. 7E shows a schematic view of the seventh level below the fourth distribution plate of the distributor element shown in FIG. 1.

FIG. 7F shows a schematic part of FIG. 7E magnified.

FIG. 8 shows a perspective side view of the internal of a mass transfer column including a distributor element, a structured packing and a collector element according to one embodiment of the present disclosure.

FIG. 9 shows a perspective side view of the internal of a mass transfer column including a plurality of distributor elements, a plurality of structured packings and a plurality of collector elements according to another embodiment of the present disclosure.

FIG. 10 shows a fractal plate according to one embodiment of the present disclosure.

FIG. 11 shows a distributor element including a first fractal plate according to another embodiment of the present disclosure.

FIG. 12 shows a perspective side view of a distributor element according to one embodiment of the present disclosure.

FIG. 13 shows a top view of the distributor element shown in FIG. 12.

FIG. 14A shows a cross-sectional view of the first level below the first distribution plate of the distributor element shown in FIG. 12.

FIG. 14B shows a schematic view of FIG. 14A.

FIG. 15A shows a cross-sectional view of the second level below the second distribution plate of the distributor element shown in FIG. 12.

FIG. 15B shows a schematic view of FIG. 15A.

FIG. 16A shows a cross-sectional view of the third level below the third fractal distribution of the distributor element shown in FIG. 12.

FIG. 16B shows a schematic view of FIG. 16A.

FIG. 17A shows a cross-sectional view of the fourth level below the fourth distribution plate of the distributor element shown in FIG. 12.

FIG. 17B shows a schematic view of FIG. 17A.

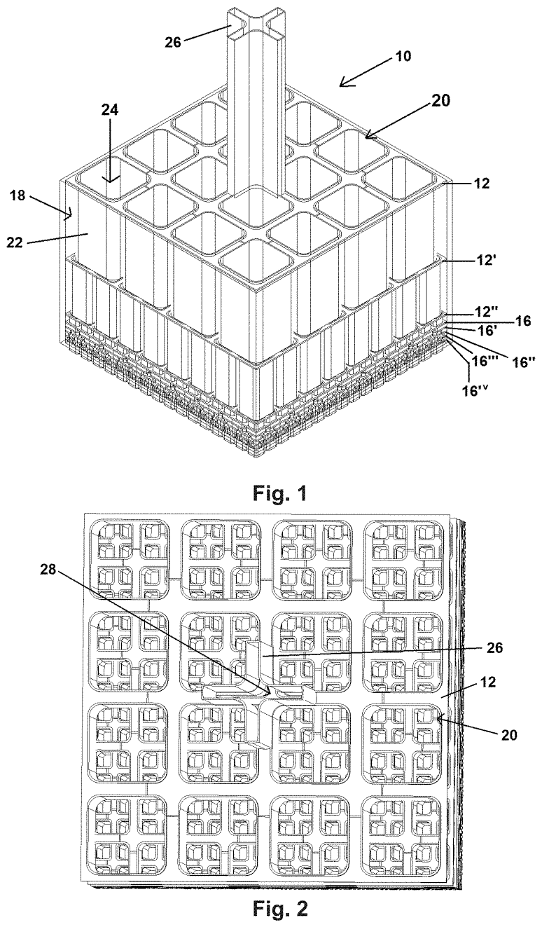

FIG. 1 shows a perspective side view of a distributor element 10 according to one embodiment of the present disclosure. The distributor element 10 comprises three fractal plates 12, 12′, 12″ and below the third fractal plate 12′″ five distribution plates 16, 16′, 16″, 16′″, 16′″. Between each two adjacent plates 12, 12′, 12″, 16, 16′, 16″, 16′″, 16′″, a level 18 is defined. Each plate 12, 12′, 12″, 16, 16′, 16″, 16′″, 16′ comprises openings 20, wherein each opening 20 has a square cross-section with rounded edges. Each opening 20 is surrounded by a wall 22 defining in each level 18 below each plate 12, 12′, 12″, 16, 16′, 16″, 16′″16^{iv} a channel 24 through which the second fluid flows. Above the center of the first fractal plate 12, an inlet 26 in the form of a pipe with a substantially cross-shaped cross-section is arranged.

FIG. 2 shows a top view of the distributor element 10 shown in FIG. 1. The uppermost fractal plate 12 comprises sixteen at least substantially square openings 20 having rounded edges and arranged in a grid-like pattern. Each of the openings 20 has the same size and form, wherein the 16 openings are arranged in the first uppermost fractal plate 12 equidistantly in 4 rows and 4 columns of openings 20. An essentially cross-shaped aperture 28 is arranged in the center of the first fractal plate 12 and is surrounded by an inlet 26 having a corresponding form.

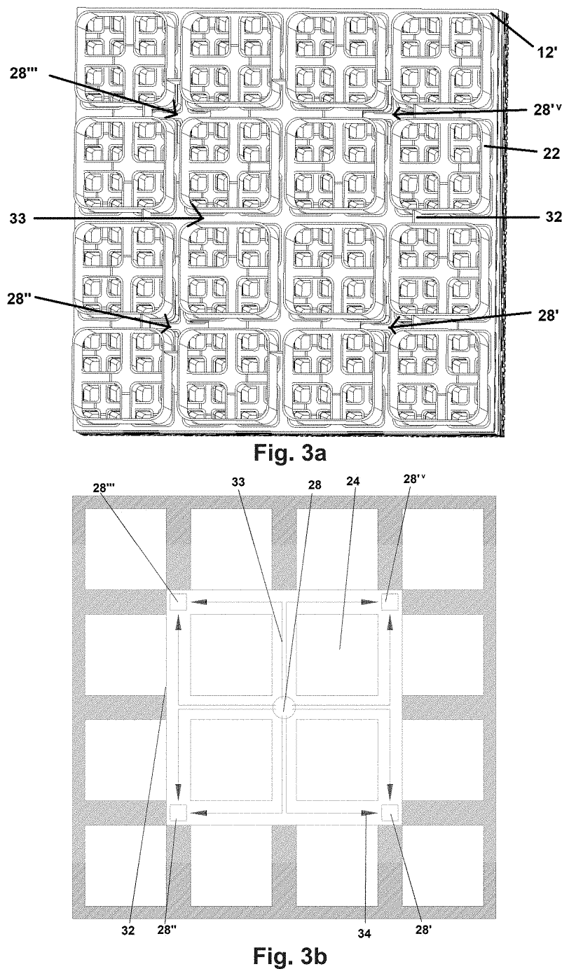

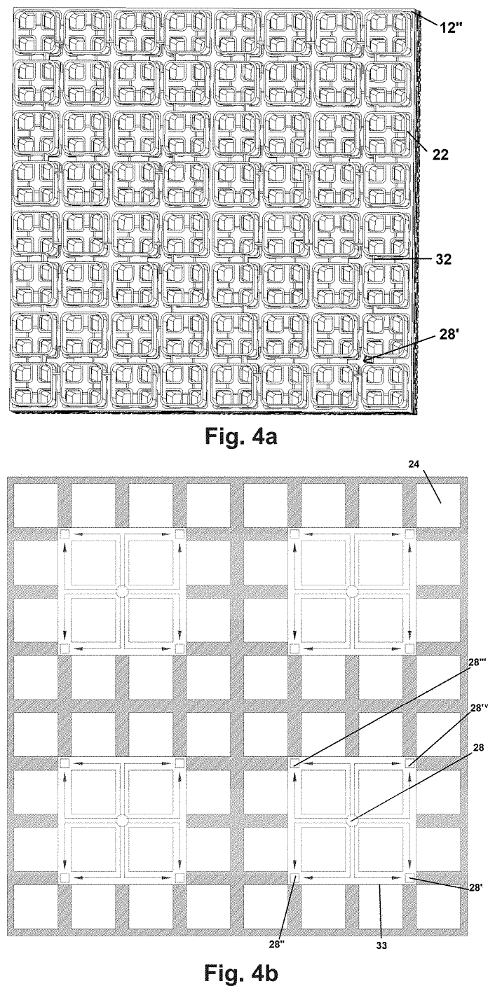

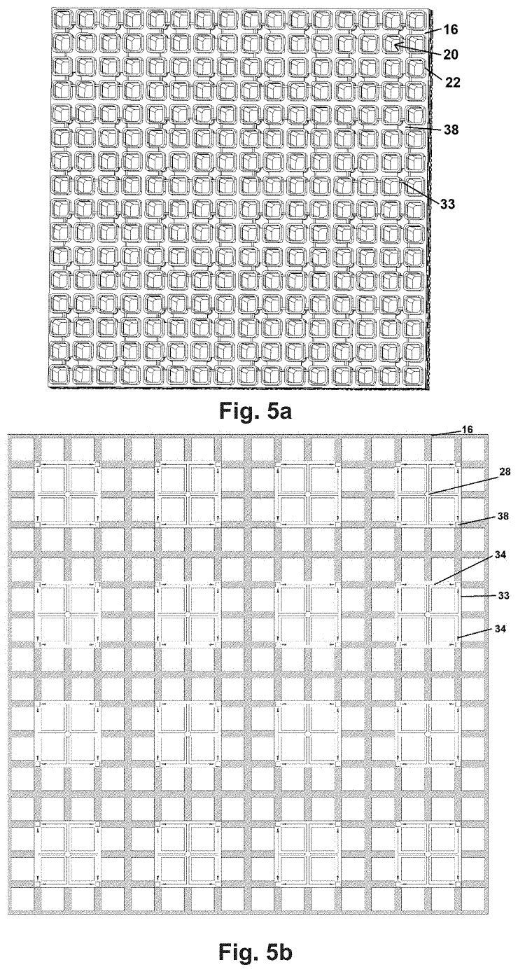

FIG. 3A shows a cross-sectional view of the first level 18 below the first fractal plate 12 and above the second fractal plate 12′ of the distributor element 10 shown in FIG. 1, and FIG. 3B shows a schematic view of FIG. 3A. Sixteen channels 24 are located below the openings 20 of the uppermost fractal plate 12, wherein each channel 24 is surrounded by a channel wall 22, which extends from the lower surface of the uppermost first fractal plate 12 onto the upper surface of the second fractal plate 12′. The circle 28 in FIG. 3B schematically shows the location of the aperture 28 formed in the uppermost fractal plate 12, through which the first fluid enters during the operation of the distributor element 10 into the first level 18. Even if the aperture 28 formed in the uppermost fractal plate 12 is, as shown in FIG. 2, essentially cross-shaped, the aperture of the plate 12 arranged above the level 18 shown in FIG. 3B is shown in FIG. 3B and in the subsequent further schematic FIG. 4B and FIG. 5B as circle, in order to show that it is an “incoming aperture”, i.e. an aperture, through which liquid flows into the level 18. In contrast thereto, the apertures 28′, 28″, 28′″, 28′^{v} of the plate 12′ arranged below the level 18 shown in FIG. 3B are shown in FIG. 3B and in the subsequent further schematic FIGS. 4B, 5B, 6B, 7A, 7C and 7E as rectangular, in order to show that they are “outcoming apertures”, i.e. apertures, through which liquid flows into the next lower level. Between some of the channel walls 22, partition walls 32 are arranged, which define a hollow space defining eight fluid paths 33 between and around the four central channels 20 of the first level 18. Each of the eight fluid paths 33 of the first level 18 have at least substantially the same length. The flow direction of the first fluid during the operation of the distributor element 10 in the eight fluid paths 33 defined in the hollow space is schematically shown by the arrows 34. Those parts of the channels 24, through which the first fluid cannot flow due to the partition walls 32, are shown in FIG. 3B shaded or hatched, respectively. Accordingly, during the operation of the distributor element 10 the first fluid entering into the hollow space of the first level 18 through the inlet 26 and the central aperture 28 of the first uppermost fractal plate 12 flows along the eight fluid paths 33 defined in the hollow space between the four central channels 24, during which the first fluid is deflected at the partition walls 32 and is directed to the four apertures 28′, 28″, 28′″, 28^{iv} of the second fractal plate 12′, from which it flows downwardly into the second level. Thus, the first fluid is distributed in the first level from one central point 28 via the eight fluid paths 33 formed by the channels 24 and the partition walls 32 and collected in the four apertures 28′, 28″, 28′″, 28^{iv}.

FIG. 4A shows a cross-sectional view of the second level below the second fractal plate 12′ and above the third fractal plate 12″ of the distributor element 10 shown in FIG. 1, and FIG. 4B shows a schematic view of FIG. 4A. Sixty four channels 24 are located below the openings 20 of the second fractal plate 12′, wherein each channel 24 is surrounded by a channel wall 22, which extends from the lower surface of the second fractal plate 12′ onto the upper surface of the third fractal plate 12″. The four circles 28 schematically show the location of the apertures 28 formed in the second fractal plate 12′, through which the first fluid enters during the operation of the distributor element 10 into the second level 18. Again, the apertures 28 of the plate 12′ arranged above the level shown FIG. 4B are shown in FIG. 4B as circle, even if the apertures 28′, 28″, 28′″, 28′^{v} formed in the upper fractal plate 12′ are, as shown in FIG. 3A, essentially cross-shaped, in order to show that they are “incoming apertures” 28, i.e. apertures 28, through which liquid flows into the level. In contrast thereto, the apertures 28′, 28″, 28′″, 28′^{v} of the plate 12″ arranged below the level shown in FIG. 4B are shown in FIG. 4B as rectangular, in order to show that they are “outcoming apertures” 28′, 28″, 28′″, 28′^{v}, i.e. apertures 28′, 28″, 28′″, 28′^{v}, through which liquid flows into the next lower level. Between some of the channel walls 22, partition walls 32 are arranged, which define 32 fluid paths 33, each fluid path defined in or by, respectively, the hollow spaces between and around four channels 20 surrounding an aperture 28′ of the second fractal plate 12′. The flow direction of the first fluid during the operation of the distributor element 10 is schematically shown by the arrows 34. Again, those parts of the channels 24, through which the first fluid cannot flow due to the partition walls 32, are shown in FIG. 4B shaded or hatched, respectively. Accordingly, during the operation of the distributor element 10 the first fluid entering into the second level through the apertures 28 flows along the 32 fluid paths 33 defined in the hollow spaces between the respective channels 24, during which the first fluid is deflected at the partition walls 32 and is directed to the sixteen apertures 28′, 28″, 28′″, 28′^{v} of the third fractal plate 12″, from which it flows downwardly into the third level. Thus, the first fluid is distributed in the second level from four apertures 28 to the sixteen apertures 28′, 28″, 28′″, 28′^{v}.

FIG. 5A shows a cross-sectional view of the third level 18 below the third fractal plate 12″ and above the first distribution plate 16 of the distributor element 10 shown in FIG. 1, and FIG. 5b shows a schematic view of FIG. 5A. Two hundred fifty six channels 24 are located below the openings 20 of the third fractal plate 12″, wherein each channel 24 is surrounded by a channel wall 22, which extends from the lower surface of the third fractal plate 12″ onto the upper surface of the first distribution plate 16. The sixteen circles 28 schematically show the location of the apertures 28′, 28″, 28′″, 28′^{v} formed in the third fractal plate 12″, through which the first fluid enters during the operation of the distributor element 10 into the third level. Again, the apertures 28 of the plate 12″ arranged above the level shown FIG. 5b are shown in FIG. 5b as circle, even if the apertures 28′, 28″, 28′″, 28′^{v} formed in the upper fractal plate 12″ are, as shown in FIG. 4A, essentially cross-shaped, in order to show that they are “incoming apertures” 28, i.e. apertures 28, through which liquid flows into the level. In contrast thereto, the apertures 38 of the distribution plate 16 arranged below the level shown in FIG. 5b are shown in FIG. 5b as rectangular, in order to show that they are “outcoming apertures” 38, i.e. apertures 38, through which liquid flows into the next lower level. However, in fact, as shown in FIG. 5A, the apertures 38 of the distribution plate 16 as well as those of all lower distribution plates 16′, 16″, 16′″, 16′^{v} are circular and not, as in the upper fractal plates 12, 12′, 12′″ essentially cross-shaped. Between some of the channel walls 22, partition walls (not shown in FIG. 5A and FIG. 5B) are arranged, which define 128 fluid paths 33, each fluid path 33 defined or formed, respectively, in the hollow spaces of the third level. The flow direction of the first fluid during the operation of the distributor element 10 is schematically shown by the arrows 34. Again, those parts of the channels 24, which cannot be flown through by the first fluid due to the partition walls 32 are shown in FIG. 5b shaded or hatched, respectively. Accordingly, during the operation of the distributor element 10 the first fluid entering into the third level through the apertures 28 flows along the 128 fluid paths 33 defined in the hollow spaces between the respective channels 24, during which the first fluid is deflected at the partition walls and is directed to the sixty four apertures 38 of the first distribution plate 16, from which it flows downwardly into the fourth level. Thus, the first fluid is distributed in the third level from sixteen apertures 28 to the sixty four apertures 38.

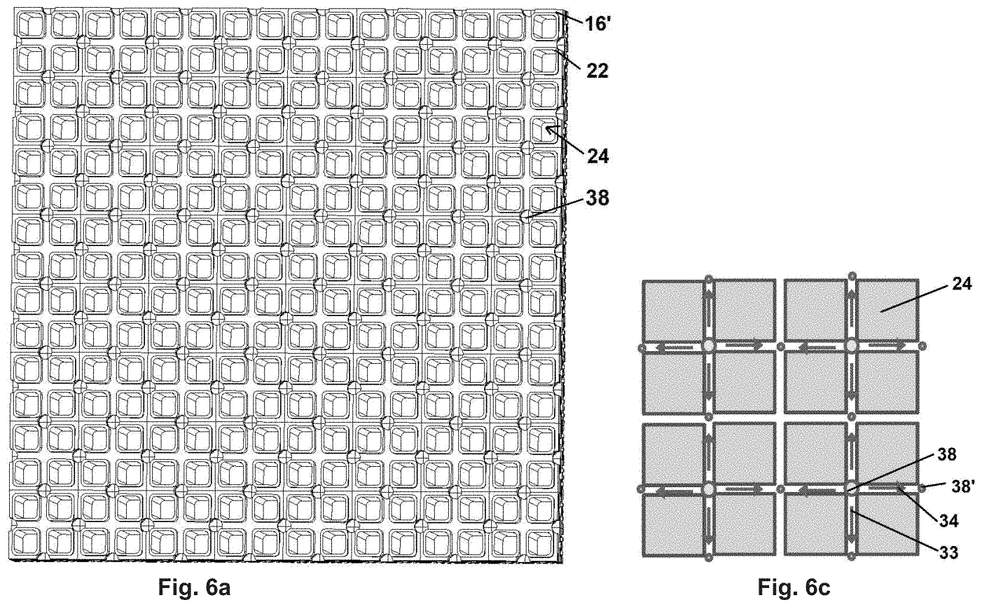

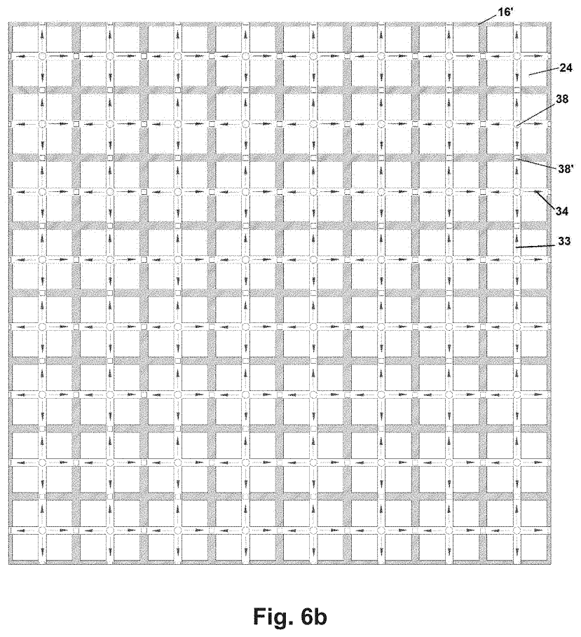

FIG. 6a shows a cross-sectional view of the fourth level below the first distribution plate 16 and above the second distribution plate 16′ of the distributor element 10 shown in FIG. 1. FIG. 6B shows a schematic view of FIG. 6A and FIG. 6C shows a part of FIG. 6B magnified. The first distribution plate 16 has the same form and same number and dimensions of openings 20 as the third fractal plate 12″, wherein the first distribution plate 16 has no apertures 38 at the crossing-points below those, in which the apertures 28′, 28″, 28′″, 28′^{v} of the third fractal plate 12″ are located, but wherein the first distribution plate 16 has apertures 38 at any crossing-point adjacent to those, in which the apertures 28′, 28″, 28′″, 28′^{v} of the third fractal plate 12″ are located. Thereby, during the operation of the distributor element 10 a further distribution of the first fluid is achieved in the fluid paths 33 defined by the hollow space(s) as shown in FIG. 6B and FIG. 6C.

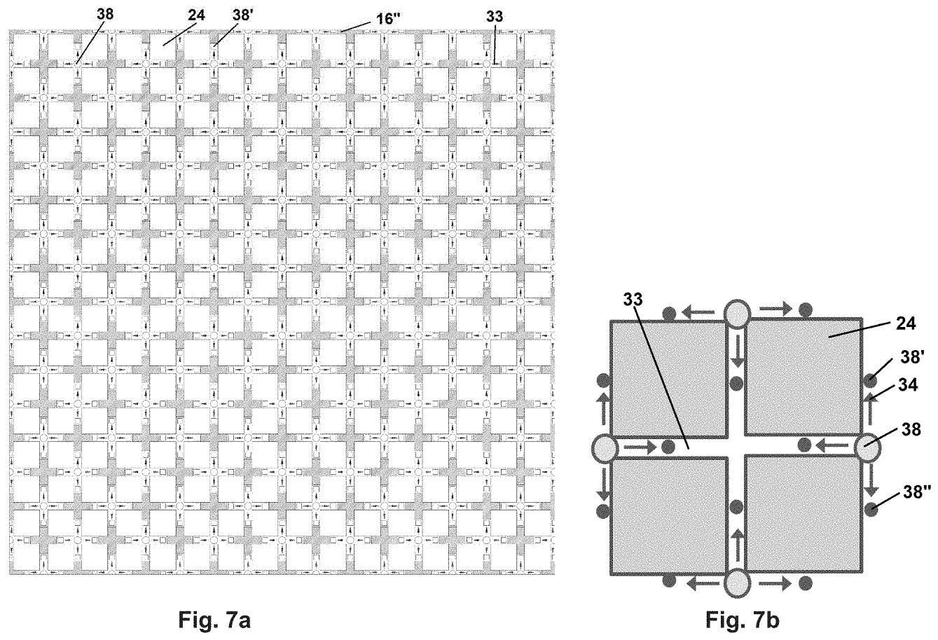

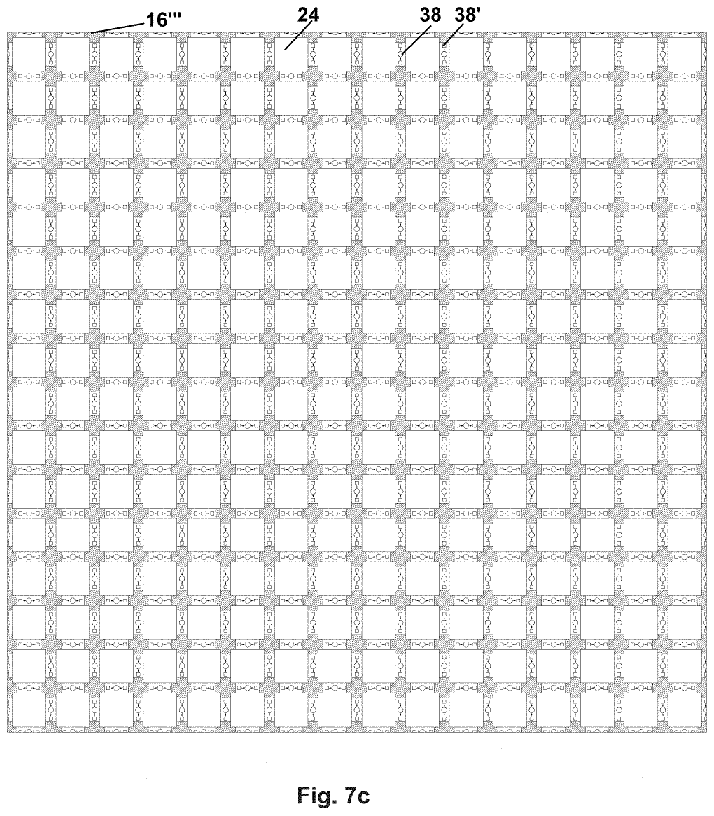

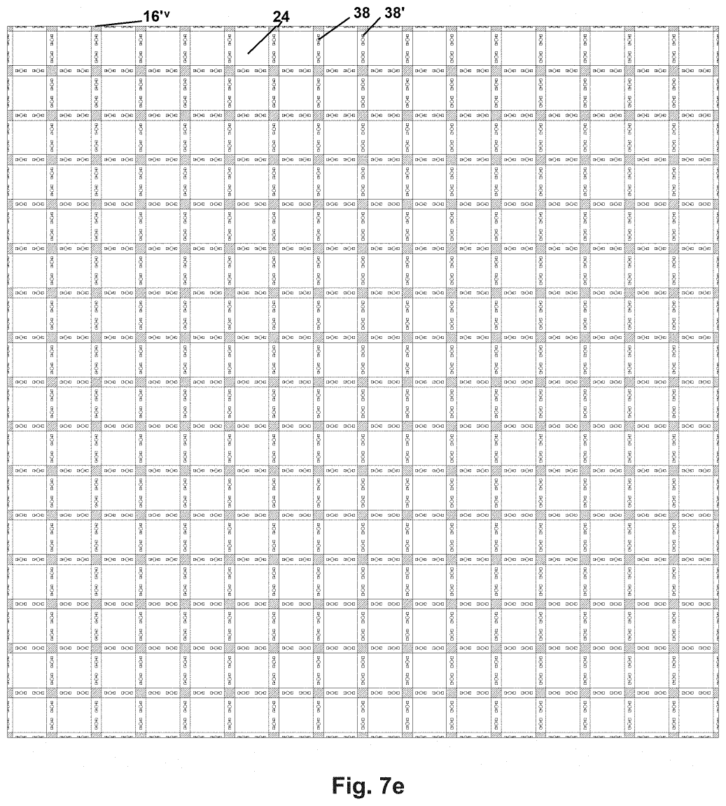

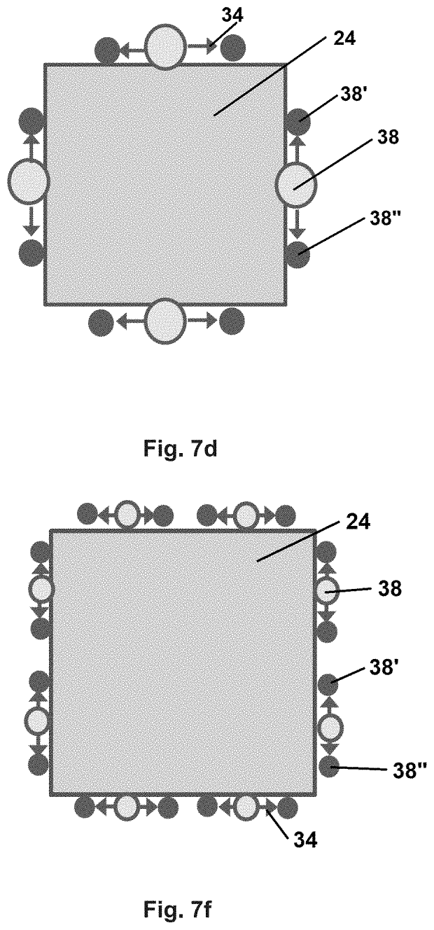

As shown in FIGS. 7A to 7E, between each adjacent of the four further distribution plates 16′, 16″, 16′″, 16^{iv} a level is defined. Each of the four further distribution plates 16′, 16″, 16′″, 16^{iv} has the same form and same number and dimensions of openings 20 as the third fractal plate 12″ and the first distribution plate 16. However, each of the further distribution plates 16′, 16″, 16′″, 16^{iv} has a higher number of apertures 38, 38′, 38″ than its adjacent upper plate 16, 16′, 16″, 16′″. This allows that any part of the hollow space(s) defining the fluid paths 33 is filled during the operation of the distributor element with the first fluid and thus via the large number of apertures 38, 38′, 38″ in the lowest of the distribution plates 16′ a particular high distribution density is achieved.

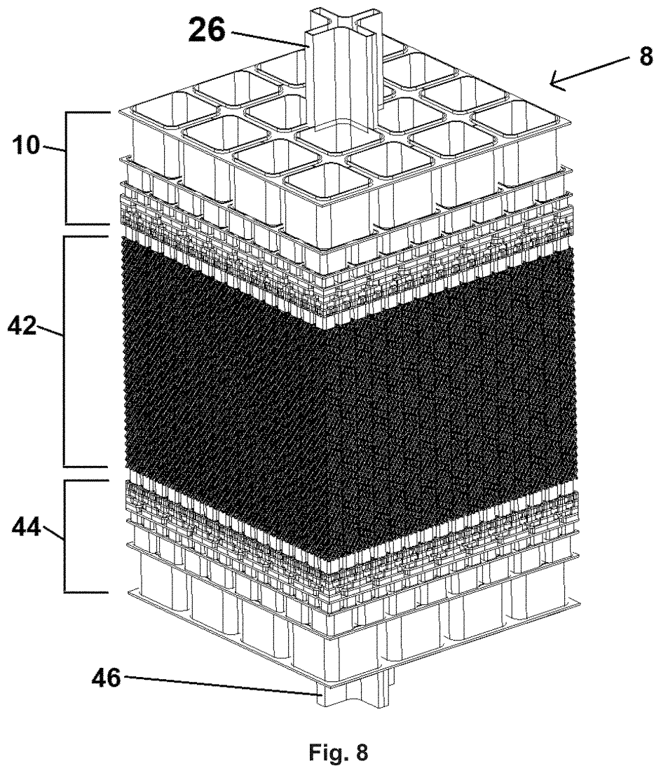

FIG. 8 shows a perspective side view of the internal 40 of a mass transfer column 8 including a distributor element 10, a structed packing 42 and a collector element 44. The mass transfer column 8 may be a rectification column 8. The distributor element 10 is composed as described above and as shown in FIG. 1 to 7. The collector element 44 is composed as the distributor element 10, but simply inverted so that the first fractal plate is the lowest plate and the fifth distribution plate is the uppermost plate. During the operation of the mass transfer column 8, liquid enters the distributor element 10 via the inlet 16 and is distributed over the cross-sectional plane as described above with reference to FIG. 1 to 7. The distributed liquid then flows downwardly onto the surface of the structured packing 42 and further downwards. Gas continuously flows in the counter-direction, i.e. from the bottom of the mass transfer column 8 upwardly. In the structured packing, an intensive mass and energy transfer between the liquid and gas occurs, since both are distributed over the large specific surface area of the structured packing 42. The liquid then flows onto the surface of the collector element 44, in which it is collected and concentrated in one point, from which it leaves the internal via the outlet 46.

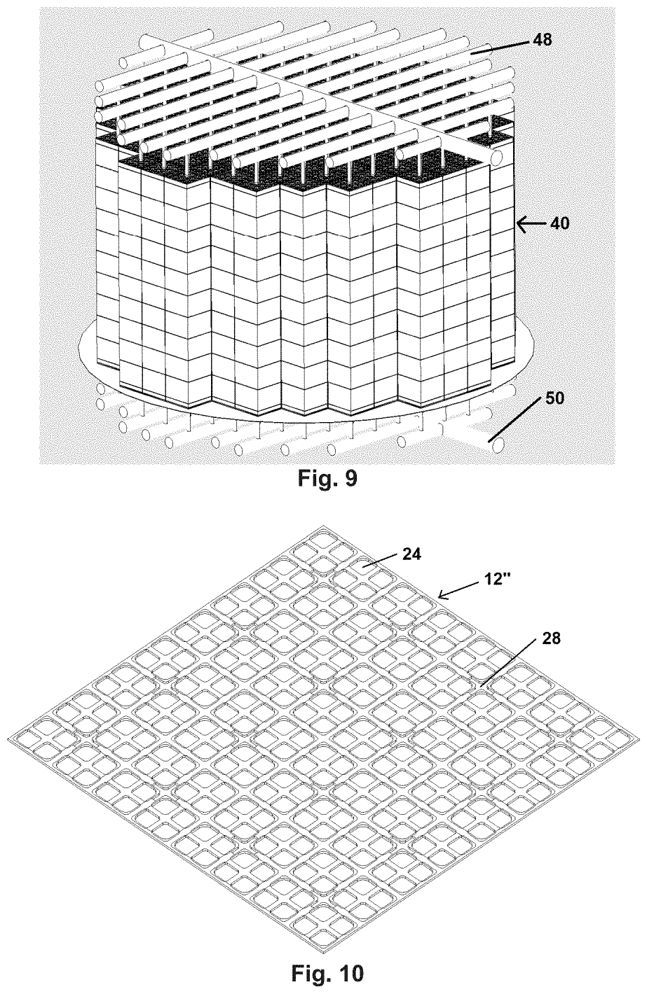

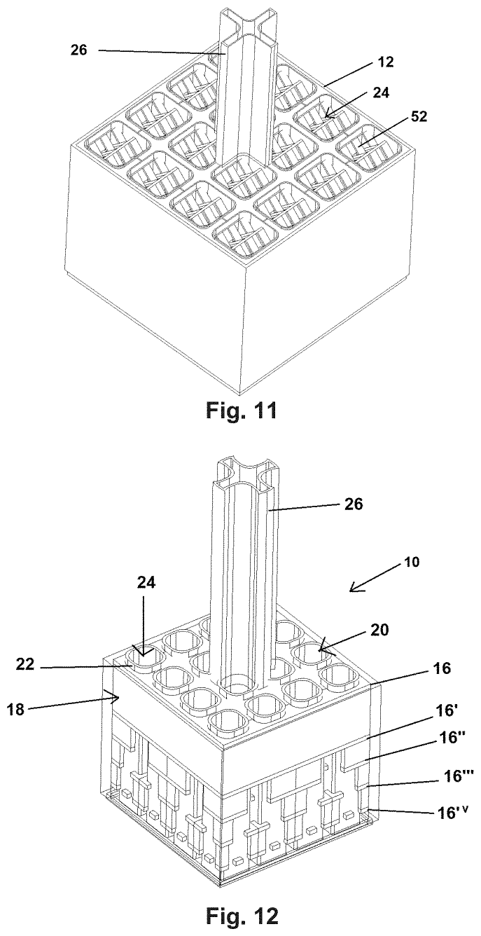

FIG. 9 shows a perspective side view of the internal of a mass transfer column 8 including a plurality of distributor elements 10, a plurality of structured packings 42 and a plurality of collectors elements 44, each of which composed as described above and as shown in FIG. 8. In order to distribute the first fluid to all of the plurality of distributor elements 10, a distribution manifold 48 is arranged above the plurality of distributor elements 10. Likewise, a collector manifold 50 is arranged below the plurality of collector elements 44.

FIG. 10 shows a fractal plate 12″ according to another embodiment of the present disclosure. The fractal plate 12″ is similar to the third fractal plate 12″ of the embodiment shown in FIGS. 1, 2 and 4 except that the dimensions of the apertures 28 having an essentially cross-shaped cross-section are slightly different.

FIG. 1 shows a distributor element including a first fractal plate 12 according to another embodiment of the present disclosure. The first fractal plate 12 is similar to the first fractal plate 12 of the embodiment shown in FIGS. 1 and 2 except that within the channels 24 static mixers 52 are arranged for mixing the second main fluid flowing therethrough during the operation of the distributor element 10.

FIG. 12 shows a perspective side view of a distributor element 10 according to one embodiment of the present disclosure. The distributor element 10 comprises five distribution plates 16, 16′, 16″, 16′″, 16^{iv}. Between each two adjacent plates 16, 16′, 16″, 16′″, 16^{iv}, a level 18 is defined. Each plate 16, 16′, 16″, 16′″, 16^{iv} comprises openings 20, wherein each opening 20 has a square cross-section with rounded edges. Each opening 20 is surrounded by a wall 22 defining in each level 18 below each plate 16, 16′, 16″, 16′″, 16^{iv} a channel 24 through which the second fluid flows. Above the center of the distribution plate 16, an inlet 26 in the form of a pipe with a substantially cross-shaped cross-section is arranged.

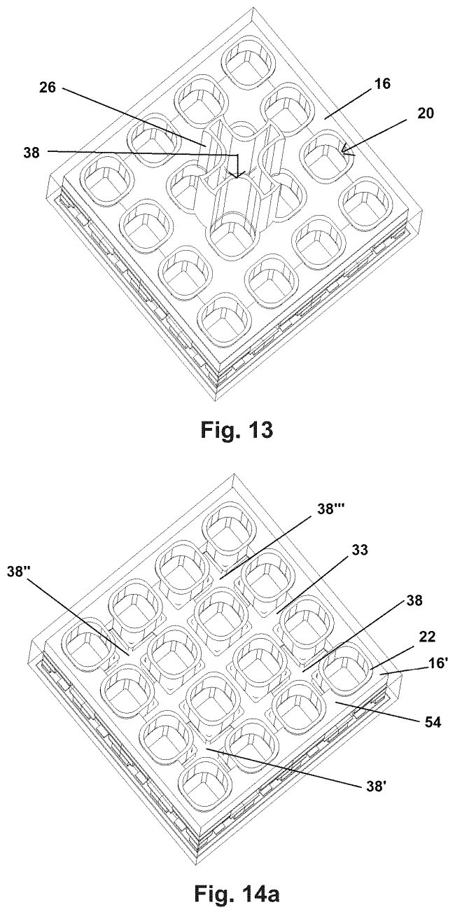

FIG. 13 shows a top view of the distributor element 10 shown in FIG. 12. The uppermost distribution plate 16 comprises sixteen at least substantially square openings 20 having rounded edges and arranged in a grid-like pattern. Each of the openings 20 has the same size and form, wherein the 16 openings are arranged in the first uppermost distribution plate 16 equidistantly in 4 rows and 4 columns of openings 20. An essentially cross-shaped aperture 38 is arranged in the center of the first distribution plate 16 and is surrounded by an inlet 26 having a corresponding form.

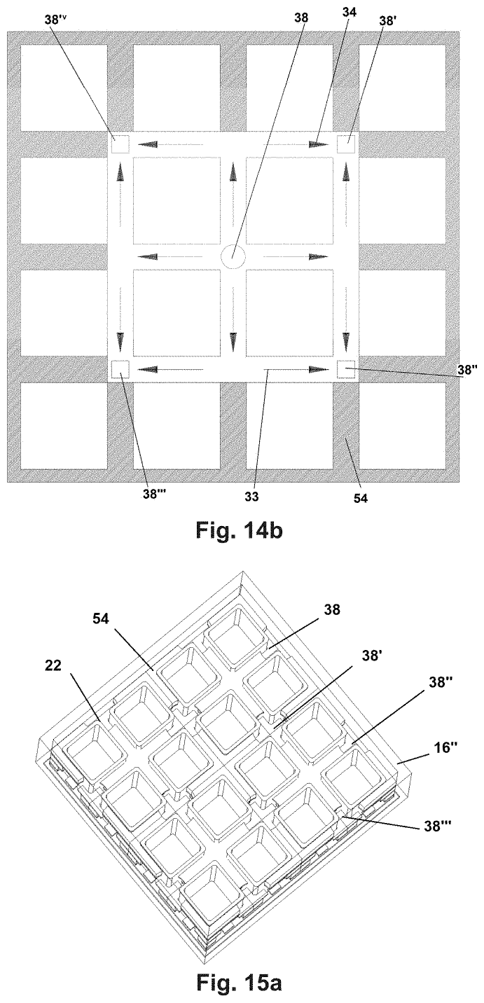

FIG. 14A shows a cross-sectional view of the first level 18 below the first distribution plate 16 and above the second distribution plate 16′ of the distributor element 10 shown in FIG. 12, and FIG. 14B shows a schematic view of FIG. 14A. Sixteen channels 24 are located below the openings 20 of the uppermost distribution plate 16, wherein each channel 24 is surrounded by a channel wall 22, which extends from the lower surface of the uppermost first distribution plate 16 onto the upper surface of the second distribution plate 16′. The circle 28 in FIG. 14B schematically shows the location of the aperture 38 formed in the uppermost distribution plate 16, through which the first fluid enters during the operation of the distributor element 10 into the first level 18. Even if the aperture 38 formed in the uppermost distribution plate 16 is, as shown in FIG. 13, essentially cross-shaped, the aperture of the plate 16 arranged above the level 18 shown in FIG. 14B is shown in FIG. 14B as circle, in order to show that it is an “incoming aperture”, i.e. an aperture, through which liquid flows into the level 18. In contrast thereto, the apertures 38′, 38″, 38′″, 38′^{v} of the plate 16′ arranged below the level 18 shown in FIG. 14B are shown in FIG. 14B as rectangular, in order to show that they are “outcoming apertures”, i.e. apertures, through which liquid flows into the next lower level. Actually, the apertures 38′, 38″, 38′″, 38′^{v} of the plate 16′ have a substantially cross-shaped cross-section. Some of the hollow spaces 54 formed between the channel walls 22, which are shown in FIG. 14B shaded or hatched, respectively are filled and thus cannot be flowed through by the first fluid. Thereby, eight fluid paths 33 between and around the four central channels 20 of the first level 18 are defined in the remaining hollow space. Each of the eight fluid paths 33 of the first level 18 have at least substantially the same length. The flow direction of the first fluid during the operation of the distributor element 10 in the eight fluid paths 33 defined by in the hollow space is schematically shown by the arrows 34. Accordingly, during the operation of the distributor element 10 the first fluid entering into the hollow space of the first level 18 through the inlet 26 and the central aperture 38 of the first uppermost distribution plate 16 flows along the eight fluid paths 33 defined in the hollow space between the four central channels 24, during which the first fluid is deflected at the walls of the filled 54 hollow spaces 54 and is directed to the four apertures 38′, 38″, 38′″, 38^{iv} of the second distribution plate 16′, from which it flows downwardly into the second level. Thus, the first fluid is distributed in the first level 18 from one central point 38 via the eight fluid paths 33 formed by the channels 24 and the walls of the filled hollow space 54 and collected in the four apertures 38′, 38″, 38′″, 48^{iv}.

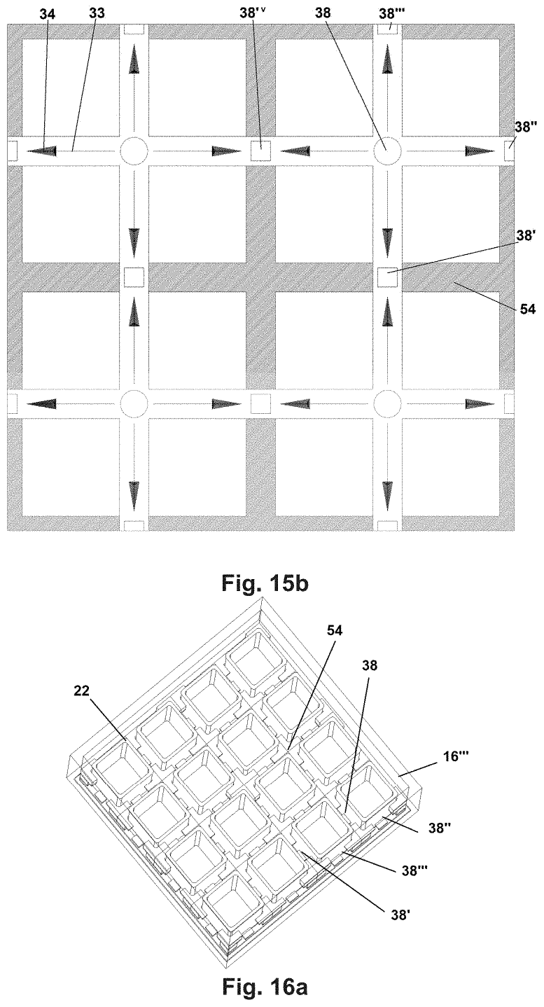

FIG. 15A shows a cross-sectional view of the second level below the second distribution plate 16′ and above the third distribution plate 16″ of the distributor element 10 shown in FIG. 12, and FIG. 15B shows a schematic view of FIG. 15A. The openings 20 and channels 24 of the second distribution plate 16′ are located at the same locations and have the same dimensions as those of the first distribution plate 16. Thus, sixteen channels 24 are located below the openings 20 of the second distribution plate 16′, wherein each channel 24 is surrounded by a channel wall 22, which extends from the lower surface of the second distribution plate 16′ onto the upper surface of the third distribution plate 16″. The four circles 38 schematically show the location of the apertures 38 formed in the second distribution plate 16′, through which the first fluid enters during the operation of the distributor element 10 into the second level. Even if the apertures 38 formed in the second distribution plate 16′ are, as shown in FIG. 14A, essentially cross-shaped, the apertures of the plate 16′ arranged above the level shown in FIG. 15B are shown in FIG. 15B as circle, in order to show that they are “incoming apertures”, i.e. apertures, through which liquid flows into the second level. The third distribution plate 16″ arranged below the second level comprises twelve apertures 38′, 38″, 38′″, 38′^{v}, which are shown in FIG. 15B as rectangular, in order to show that they are “outcoming apertures” 38′, 38″, 38′″, 38′^{v}, i.e. apertures 38′, 38″, 38′″, 38′^{v}, through which liquid flows into the next lower level. Actually, the twelve apertures 38′, 38″, 38′″, 38′^{v} of the third distribution plate 16″ have a circular cross-section, as shown in FIG. 15A. Some of the hollow spaces 54 formed between the channel walls 22, which are shown in FIG. 15B shaded or hatched, respectively are filled and thus cannot be flowed through by the first fluid.

Thereby, sixteen fluid paths 33 between and around the channels 20 of the second level are defined in the remaining hollow space. The flow direction of the first fluid during the operation of the distributor element 10 is schematically shown by the arrows 34. Accordingly, during the operation of the distributor element 10 the first fluid entering into the second level through the apertures 38 flows along the 16 fluid paths 33 defined in the hollow spaces between the respective channels 24, during which the first fluid is deflected at the walls 32 of the filled hollow space 54 and is directed to the twelve apertures 38′, 38″, 38′″, 38′^{v} of the third distribution plate 16″, from which it flows downwardly into the third level. Thus, the first fluid is distributed in the second level from four apertures 38 to the twelve apertures 38′, 38″, 38′″, 38′.

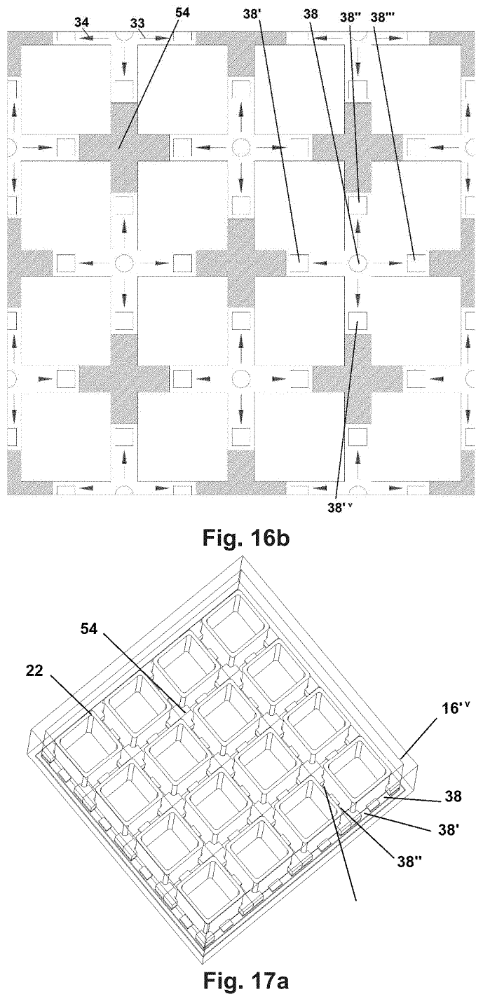

FIG. 16A shows a cross-sectional view of the third level below the third distribution plate 16″ and above the fourth distribution plate 16′″ of the distributor element 10 shown in FIG. 12, and FIG. 16B shows a schematic view of FIG. 16A. The openings 20 and channels 24 of the fourth distribution plate 16′″ are located at the same locations and have the same dimensions as those of the first, second and third distribution plates 16, 16′, 16″. Thus, sixteen channels 24 are located below the openings 20 of the third distribution plate 16″, wherein each channel 24 is surrounded by a channel wall 22, which extends from the lower surface of the third distribution plate 16″ onto the upper surface of the fourth distribution plate 16′″. The twelve circles 28 schematically show the location of the apertures 38′, 38″, 38′″, 38′^{v} formed in the third distribution plate 16″, through which the first fluid enters during the operation of the distributor element 10 into the third level. The fourth distribution plate 16′″ arranged below the third level comprises forty apertures 38′, 38″, 38′″, 38′″, which are shown in FIG. 16B as rectangular, in order to show that they are “outcoming apertures” 38′, 38″, 38′, 38′^{v}, i.e. apertures 38′, 38″, 38′″, 38′^{v}, through which liquid flows into the next lower level. Actually, the forty apertures 38′, 38″, 38′″, 38′^{v} of the fourth distribution plate 16′″ have the form of a long rectangular, as shown in FIG. 16A. Some of the hollow spaces 54 formed between the channel walls 22, which are shown in FIG. 16B shaded or hatched, respectively are filled and thus the first fluid cannot flow therethrough. Thereby, forty fluid paths 33 between and around the channels 20 of the third level are defined in the remaining hollow space. The flow direction of the first fluid during the operation of the distributor element 10 is schematically shown by the arrows 34. Accordingly, during the operation of the distributor element 10 the first fluid entering into the third level through the apertures 38 flows along the 40 fluid paths 33 defined in the hollow spaces between the respective channels 24, during which the first fluid is deflected at the walls 32 of the filled hollow space 54 and is directed to the forty apertures 38′, 38″, 38′″, 38′^{v} of the fourth distribution plate 16′″, from which it flows downwardly into the fourth level. Thus, the first fluid is distributed in the third level from twelve apertures 38 to the forty apertures 38′, 38″, 38′″, 38′^{v}.

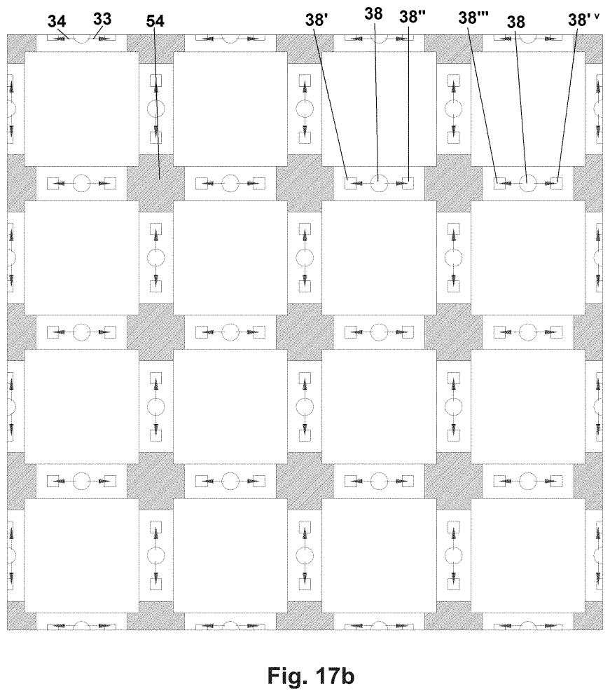

FIG. 17A shows a cross-sectional view of the fourth level below the fourth distribution plate 16′″ and above the fifth distribution plate 16′″ of the distributor element 10 shown in FIG. 12, and FIG. 17B shows a schematic view of FIG. 17A. The openings 20 and channels 24 of the fifth distribution plate 16′″ are located at the same locations and have the same dimensions as those of the first, second, third and fourth distribution plates 16, 16′, 16″, 16′″. Thus, sixteen channels 24 are located below the openings 20 of the fourth distribution plate 16′″, wherein each channel 24 is surrounded by a channel wall 22, which extends from the lower surface of the fourth distribution plate 16′″ onto the upper surface of the fifth distribution plate 16″. The forty circles 28 schematically show the location of the apertures 38′, 38″, 38′″, 38′^{v} formed in the fourth distribution plate 16′″, through which the first fluid enters during the operation of the distributor element 10 into the fourth level. Even if the apertures 38 formed in the fourth distribution plate 16′″ have, as shown in FIG. 16A, the form of a long rectangular, the apertures of the plate 16′″ arranged above the level shown in FIG. 17B are shown in FIG. 17B as circle, in order to show that they are “incoming apertures”, i.e. apertures, through which liquid flows into the second level. The fifth distribution plate 16′^{v} arranged below the fourth level comprises 82 apertures 38′, 38″, 38′″, 38′^{v}, which are shown in FIG. 17B as rectangular, in order to show that they are “outcoming apertures” 38′, 38″, 38′″, 38′^{v}, i.e. apertures 38′, 38″, 38′″, 38′^{v}, through which liquid flows into the next lower level. Actually, the 82 apertures 38′, 38″, 38′″, 38′^{v} of the fifth distribution plate 16′^{v} have the form of a long rectangular, as shown in FIG. 17A. Some of the hollow spaces 54 formed between the channel walls 22, which are shown in FIG. 17B shaded or hatched, respectively are filled and thus cannot be flowed through by the first fluid. Thereby, 82 fluid paths 33 between and around the channels 20 of the fourth level are defined in the remaining hollow space. The flow direction of the first fluid during the operation of the distributor element 10 is schematically shown by the arrows 34. Accordingly, during the operation of the distributor element 10 the first fluid entering into the fourth level through the apertures 38 flows along the 82 fluid paths 33 defined in the hollow spaces between the respective channels 24, during which the first fluid is deflected at the walls 32 of the filled hollow space 54 and is directed to the 82 apertures 38′, 38″, 38′″, 38′^{v} of the fifth distribution plate 16′^{v}, from which it flows downwardly. Thus, the first fluid is distributed in the fourth level from forty apertures 38 to the 82 apertures 38′, 38″, 38′, 38′^{v}.

1. A distributor element for uniformly distributing a first fluid on a cross-sectional plane or collecting the first fluid distributed on the cross-sectional plane, wherein a second fluid flows in at least one of co-current flow and counter-current flow with regard to the first fluid through the distributor element, the distributor element comprising:
at least three plates arranged substantially parallel to each other, one of a plurality of levels being defined between each of two adjacent plates of the at least three plates,
each of the at least three plates comprising a number of openings,
each of the levels having walls arranged therein, each of the walls extending from one side of one of the at least three plates onto an adjacent side of an adjacent plate of the at least three-plates such that each of the walls defines, one of a plurality of channels through which the second fluid flows,
the channels fluid-tightly connecting all of the openings between adjacent plates of the at least three plates, in each of the levels between the walls defining the channels, one or more hollow spaces being formed, through which the first fluid is configured to flow,
each of the at least three plates comprising at least one aperture not being fluid-tightly connected with one or more of the openings of an adjacent plate of the at least three plates by one of the channels, the at least one aperture being arranged adjacent to the one or more hollow spaces of adjacent levels such that in each level between the at least one aperture of the adjacent plate, at least two fluid paths extend in the one or more hollow spaces of the level,
all of the at least two fluid paths of each level having a substantially same length,
a number of fluid paths increasing, as seen in a direction from one outermost plate to an opposite outermost plate of the at least three plates of the distributor element, at least for 75% of the at least three plates from level to level, and
the channels through which the second fluid flows are fluid-tightly separated by the walls from all of the one or more hollow spaces defining the fluid paths through which the first fluid is configured to flow.

2. (canceled)

3. The distributor element in accordance with claim 1, wherein the number of fluid paths increases, as seen in the direction from the one outermost plate to the opposite outermost plate of the at least three plates of the distributor element, at least for 80% of the at least three plates from level to level.

4. The distributor element in accordance with claim 1, wherein, as seen in the direction from the one outermost plate to the opposite outermost plate of the at least three plates of the distributor element, at least one of a number of channels and a number of the at least one aperture of one of the at least three plates increases from level to level.

5. The distributor element in accordance with claim 1, wherein lengths of all of the at least two fluid paths extending from an aperture of the first outermost plate to an aperture of the opposite outermost plate of the distributor element are substantially the same.

6. The distributor element in accordance with claim 1, wherein;
all of the openings of each of the at least three plates are at least substantially regularly arranged in each of the at least three plates,
each of distances between a center point of one of the openings and center point of a closest adjacent one of the openings of at least one of the at least three plates is 80 to 120% of an average distance of the center points of all of the openings and the closest adjacent openings of a respective one of the at least three plates,
the average distance of the center points of all openings with the closest adjacent openings of a respective plate is determined by: measuring the distances between the center point of each of the openings and the center point of the closest opening of the respective one of the at least three plates, summing up all the measured distances of the respective one of the at least three plates, and dividing the sum by the number of openings of the respective one of the at least three plates.

7. The distributor element in accordance with claim 1, wherein:
the openings of each of the at least three plates are arranged in a substantially grid-like pattern in each of the at least three plates, and
the openings of each of the at least three plates are arranged in the respective plate one of the at least three plates in (2)^{m} rows and (2)^{m} columns, wherein m is an integer from 1 to 10.

8. The distributor element in accordance with claim 1, wherein:
all of the at least one aperture of each of the at least three plates are at least substantially regularly arranged in each of the at least three plates,
each of the distances between a center point of one of the at least one aperture and a center point of a closest adjacent aperture of the at least one aperture of each of the at least three plates is 80 to 120% of an average distance of the center points of all of the at least one aperture and the closest adjacent apertures of the at least one aperture of a respective plate,
the average distance of the center points of all of the at least one aperture with the closest adjacent aperture of the at least one aperture of the respective plate is determined by: measuring the distances between the center point of each of the at least one aperture and the center point of the closest aperture of the respective one of the at least three plates, summing up all the measured distances of the respective one of the at least three plates, and dividing the sum by a number of the at least one aperture of the respective one of the at least three plates.

9. The distributor element in accordance with claim 1, comprising two to fifteen fractal plates, wherein;
each of the fractal plates comprises a lower number of openings than a fractal plate that is adjacent in the direction from the one outermost plate to the opposite outermost plate of the distributor element,
all of the fractal plates are adjacent to each other, with a first fractal plate of the fractal plates being the one outermost plate of the distributor element, and
wherein the number of openings in each of the fractal plates is 4×(4)ⁿ, wherein n is a number of a respective fractal plate in relation to the first fractal plate, with the first fractal plate being fractal plate 1.

10. The distributor element in accordance with claim 1, wherein:
at least one of the at least three plates is a distribution plate such that there is at least one distribution plate, and
each of the at least one distribution plate comprises a same number of openings as an adjacent plate that is adjacent in a direction opposite to the direction from the one outermost plate to the opposite outermost plate of the distributor element, and, if no such adjacent plate is present, a same number of openings as a plate that is adjacent in the direction from the one outermost plate to the opposite outermost plate of the distributor element.

11. The distributor or collector element in accordance with claim 10, wherein each of the at least one distribution plate has a same form as the adjacent plate that is adjacent in the direction opposite to the direction from the one outermost plate to the opposite outermost plate, and, if no such adjacent plate is present, a same form as a plate that is adjacent in the direction from the one outermost plate to the opposite outermost plate, and
the openings are formed in each of the at least one distribution plate at same locations as in a plate the adjacent plate that is adjacent in the direction opposite to the direction from the one outermost late to the opposite outermost plate and, if no such adjacent plate (12″, 16, 16′, 16″, 16′″) is present, at same locations as in a plate that is adjacent in the direction from the one outermost plate to the opposite outermost plate.

12. The distributor element in accordance with claim 10, comprising one to three distribution plates, wherein each of the distribution plates, has a higher number of the at least one aperture than a plate that is adjacent in the direction opposite to the direction from the one outermost plate to the opposite outermost plate, if present.

13. The distributor or collector element in accordance with claim 1, comprising only fractal plates and including three to fifteen fractal plate.

14. The distributor or collector element in accordance with claim 1, comprising only distribution plates and including three to ten distribution plates.

15. The distributor element in accordance with claim 1, comprising at least one fractal plate and at least one distribution plate, wherein all of the at least one distribution plates are arranged, as seen in the direction from the one outermost plate to the opposite outermost plate of the distributor element, behind all of the at least one fractal plate.

16. An apparatus comprising at least one distributor element in accordance with claim 1, wherein:
the apparatus is selected from the group consisting of: a mass transfer column, a mixer, a disperser, a foaming device, a chemical reactor, a crystallizer and an evaporator, or
the apparatus is a mass transfer column and comprises, below the at least one distributor element, a mass transfer structure selected from the group consisting of: contact trays, random packings and structured packings, or
the apparatus is a mass transfer column and comprises, below the at least one distributor element, a mass transfer structure, the mass transfer structure having a honeycomb shape including capillaries, the walls defining the channels being step-shaped, made of tissue, or arbitrarily formed open-cell foams, or
the apparatus comprises, below the at least one distributor element a mass transfer structure, the mass transfer structure comprising a contact zone designed to conduct the second fluid and designed such that the first fluid can be brought into contact with the second fluid, wherein in the contact zone at least one flow breaker is provided for interrupting a flow of the second fluid, or
the apparatus comprises, below the at least one distributor element, a mass transfer structure selected from the group consisting of: tissues, open-pored materials, capillaries, step structures and arbitrary combinations of two or more thereof.

17. A method for uniformly distributing a first fluid on a cross-sectional plane of a distributor element in accordance with claim 1 and collecting the first fluid distributed on the cross-sectional plane, the method comprising:
flowing the first fluid into at least one of the one or more hollow spaces defining the fluid paths; and
flowing the second fluid through the channels of the distributor element,
the distributor element being provided in one of; a mass transfer column, a mixer, a disperser, a foaming device and a chemical reactor.
